(19) United States
(12) Patent Application Publication
(10) Pub. No.: US 2014/0019998 A1
(43) Pub. Date: Jan. 16, 2014

(54) PARALLEL SYSTEM AND METHOD THEREOF

(71) Applicant: Ming-Chang Huang, Taoyuan County (TW)

(72) Inventor: Ming-Chang Huang, Taoyuan County (TW)

(21) Appl. No.: 13/568,156

(22) Filed: Aug. 7, 2012

Related U.S. Application Data
(63) Continuation-in-part of application No. 13/545,015, filed on Jul. 10, 2012.

(51) Int. Cl. G06F 9/44; G06F 9/46

(52) U.S. Cl. 719/321

(57) ABSTRACT

A parallel system for running a virtual machine independent of a master system is described, wherein the applications run on a subsystem has its own dedicated monitor and input devices to enable true parallel processing with applications run the master system.

One embodiment according to the present invention comprises: a master system comprising a first set of I/O channels, capable of running a first application; and a subsystem, electrically connecting to the first set of I/O channels of the master system, having a corresponding device diver of the master system, wherein the device diver is linked to the first application to enable the first application to use the subsystem through the first set of I/O channels and the device driver independent of the master system.

### CROSS-REFERENCE TO RELATED APPLICATION

This application is a continuation-in-part of U.S. patent application Ser. No. 13/545,015, filed Jul. 10, 2012, titled “A Virtualization System and Method thereof” which is hereby incorporated herein by reference.

### BACKGROUND OF THE INVENTION

1. Field of the Invention

The invention relates in general to a virtualization system using a computer and, in particular, to a virtualization system using an electronic computing device.

2. Description of the Prior Art

A notebook or a desktop PC can uses VM to run additional application on another big screen monitor in addition to the applications running on its original equipped display; however, it can only control one monitor or display at a time because there is only one keyboard or mouse available to the notebook or PC. What has been done so far is to share the keyboard or mouse for one monitor at a time. Therefore, it is not very convenient if the applications require separate control for each monitor so that the applications can run in parallel without waiting for each other.

VM can run as an application on an operating system of a computing device or VM can run by a distinct OS independent of the original operating system. For a portable device, it is more convenient to run a VM as an application. Due to the fact that the power and performance of a mobile phone continues to increase, the mobile phone can be used as a notebook or a PC as well except that the screen size is limited for some applications requiring bigger screen. In addition, if one wants to make or receive a phone call at any time, the power and performance of the mobile phone will be wasted if it can not be used for running some applications at the same time while making the phone calls.

Conventional VM uses the hardware resources in the master system, and therefore it can not add hardware resources after the master system is powered up and VM is running.

In summary, current virtualization implementations on a notebook or portable devices mentioned above are not providing flexibility and convenience for running two applications on two or more monitors independently. Accordingly, what is needed is a solution to resolve the above issues.

### SUMMARY OF THE INVENTION

One object of the present invention is to provide a virtualization system for running virtual machine independently, wherein each of the virtual machine has its own dedicated output and input devices to enable true parallel processing.

One embodiment according to the present invention comprises: a master system comprising a first set of I/O channels, capable of running a first virtual machine; and a subsystem, adapted for connecting the first set of I/O channels of the master system, having a corresponding device diver of the master system, wherein the device diver is linked to the first virtual machine to enable the first virtual machine to use the subsystem through the first set of I/O channels and the device driver independent of the master system.

One embodiment according to the present invention is a virtualization system, comprising: a computing device having a first video output channel and a first input channel, capable of running a first virtual machine; a connecting bus, for connecting the first video output channel and the first input channel of the computing device; an external device, adapted to connected to the connecting bus, for receiving the output signals of the first video output channel and providing input signals to the first input channel of the computing device, wherein the first virtual machine is linked to the external device when the external device is detected by the computing device and dispatched to the first virtual machine.

In one embodiment, a method to run a virtualization system is described, wherein the virtualization system comprises a computing device having a first video output channel and a first input channel, capable of running a first virtual machine; a connecting bus connecting the video output channel and the input channel of the computing device; an external device, adapted to connected to the connecting bus, for receiving the output signals of the first video output channel and providing input signals to the first input channel of the computing device, comprising the steps of: running the first virtual machine; turning on the first video output channel for generating output video signals to the external device when the external device is attached to the connecting bus and detected by the computing device; reading identification and information of the external device; loading a driver for the external device; and dispatching the external device to the first virtual machine.

One object of the present invention is to provide a subsystem for running a first application independently of the master system, wherein the first application has its own dedicated output and input devices to enable true parallel processing.

One embodiment according to the present invention comprises: a master system comprising a first set of I/O channels, capable of running a first application; and a subsystem, adapted for connecting the first set of I/O channels of the master system, having a corresponding device diver of the master system, wherein the device diver is linked to the application to enable the first application to use the subsystem through the first set of I/O channels and the device driver independent of the master system.

One embodiment according to the present invention is a parallel system, comprising: a computing device having a first video output channel and a first input channel, capable of running a first application; a connecting bus, for connecting the first video output channel and the first input channel of the computing device; an external device, adapted to connected to the connecting bus, for receiving the output signals of the first video output channel and providing input signals to the first input channel of the computing device, wherein the first application is linked to the external device when the external device is detected by the computing device and dispatched to the first application.

In one embodiment, a method to run a parallel system is described, wherein the parallel system comprises a computing device having a first video output channel and a first input channel, capable of running a first application; a connecting bus connecting the video output channel and the input channel of the computing device; an external device, adapted to connected to the connecting bus, for receiving the output signals of the first video output channel and providing input signals to the first input channel of the computing device, comprising the steps of: running the first application; turning on the first video output channel for generating output video signals to the external device when the external device is attached to the connecting bus and detected by the computing device; reading identification and information of the external device; loading a driver for the external device; and dispatching the external device to the first application.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A-1B shows a schematic diagram in accordance with one embodiment for running virtual machine on a master system.

FIG. 2A-2B shows a graphic user interface to select a virtual machine;

FIG. 3 shows the master system can provide multiple video channels;

FIG. 4A shows a flow chart to start the VM in accordance with one embodiment;

FIG. 4B-4C shows flow charts to close the VM in accordance with one embodiment;

FIG. 5 shows a mechanical base to sit the master system, and the base has a connector to connect the I/O channels of a master system.

FIG. 6 shows an adaptor which has a first wireless antenna to replace a second wireless antenna in a master system;

FIGS. 7A and 7B shows different ways to connect power supply to the external adaptor;

FIG. 8A-8B shows a schematic diagram in accordance with another embodiment for running application on a master system.

FIG. 9A-9B shows a graphic user interface to select an application in accordance with another embodiment;

FIG. 10A shows a flow chart to start the APP in accordance with another embodiment; and

FIG. 10B-10C shows flow charts to close the APP in accordance with another embodiment;

### DETAILED DESCRIPTION OF THE INVENTION

The detailed explanation of the present invention is described as following. The described preferred embodiments are presented for purposes of illustrations and description, and they are not intended to limit the scope of the present invention.

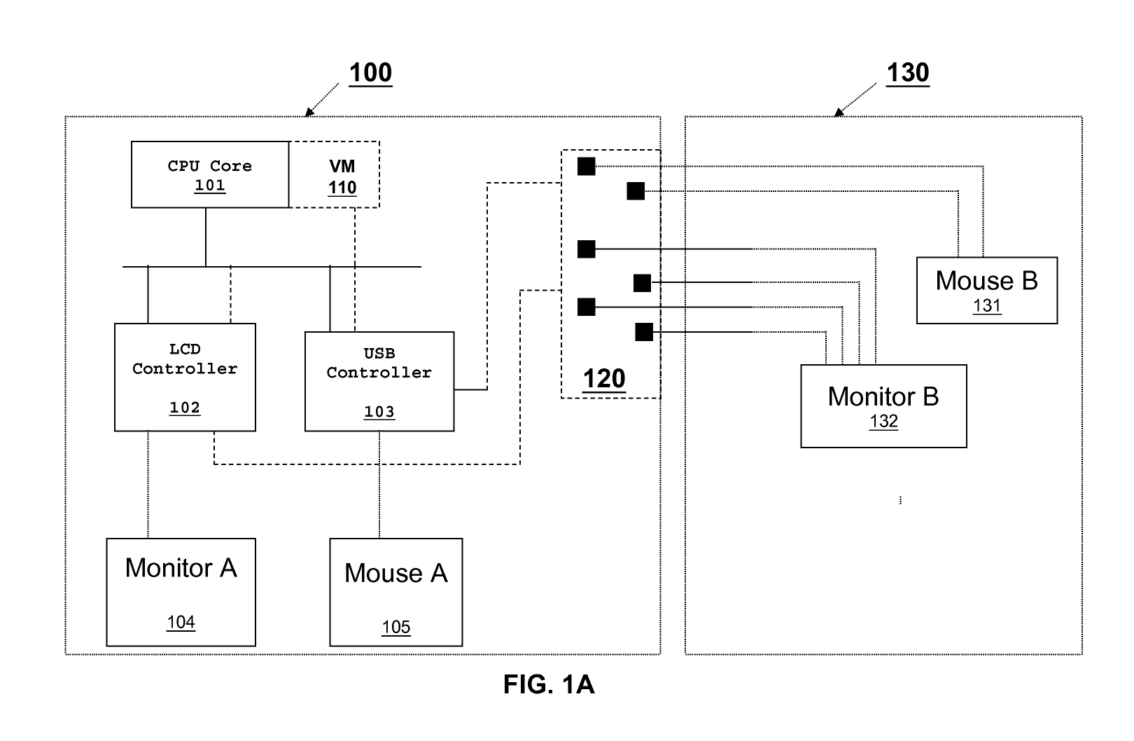

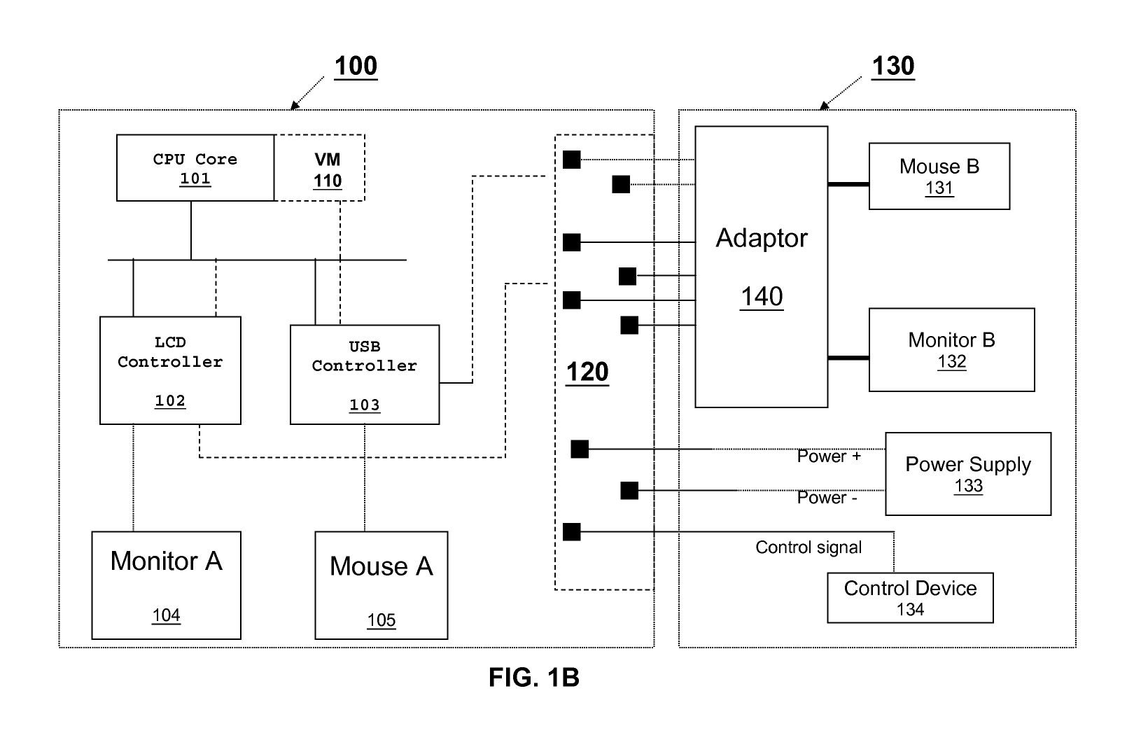

FIG. 1A shows a schematic diagram in accordance with one embodiment for running a virtual machine 110 on an external monitor 132 while a master system 100 is working on its own, which means the virtual machine 110 has its own display or monitor 132 independent of the display or monitor 104 used by the master system 100. In addition, the virtual machine 110 can have its on input device such as a mouse 131 independent of the input devices such as a mouse 105 used by the master system 100 as well. The master system 100 is connected to an external subsystem 130 which includes some I/O devices, such as a mouse 131, a keyboard, a monitor 132, a touch-panel, audio speaker, etc., which provides a great deal of flexibility and adaptability to any environment, such as connecting the subsystem into a desktop, a notebook, a mobile phone or any computing devices capable of running a virtual machine. By doing this way, the I/O devices used by the applications running on the master system 100 can be independent of the I/O devices used by the virtual machine 110; and the I/O devices in the subsystem can be added and configured through loading a device driver corresponding to the subsystem 130 after the master system 100 is power-up and running.

Please continue to refer to FIG. 1A. In one embodiment, the master system 100 has a connector 120 for connecting with the subsystem 130. The mouse 131 is connected to the internal bus or I/O channels of master system, the driver for the mouse 131 will be loaded when the mouse 131 is connected to the master system through the connector 120. Likewise, the monitor 132 is connected to the internal bus or I/O channels of master system, the driver for the monitor 132 will be loaded when the monitor 132 is connected to the master system through the connector 120.

Please note that the master system can connect to the subsystem in passing-through mode, that is, the devices of the subsystem can be connected to the master system directly without using the connector 120. For example, a mouse of the subsystem can be connected to the master system through an existing USB port of the master system and a monitor of the subsystem can be connected to the master system through an existing HDMI port of the master system; and the subsystem can be detected by the master system through detecting the ID of the mouse or the monitor in the subsystem.

In addition, an I/O channel of the master system can be connected to an external port through the subsystem, for example, an I/O channel of the master system can be connected to a network through the subsystem, wherein the subsystem will connect the I/O channel to the network through a network port in the subsystem. Alternatively, a new device can be attached to a port of the subsystem and the new device can be assigned to the subsystem once the ID of the device is known and the loading process for the new device is done. Another example is that the subsystem will pass an I/O channel from the master system to another port in the subsystem, for example, the subsystem will receive videos on an I/O channel from the master system and transmit the video to another video port in the subsystem.

In another embodiment, as shown in FIG. 1B, an adaptor 140 which connects to a set of I/O channels of master system and can be used to convert signals form the I/O channels into suitable signals for connecting with all the devices in the subsystem 130 to improve flexibility. Adaptor comprise several kinds of interface, for example, one I/O channel has a number of pin for connecting to an input device, such as a mouse; another I/O channel has a number of pins for connecting to a display, such as a monitor; yet another I/O channel has a number of pins for connecting to an audio speaker; Please note that each I/O channel may have any number of pins assigned in the adaptor, it. The I/O channel can be connected to a device directly or indirectly through some conversions, for example, the video signals can be in VGA form or LVDS form, and they can be converted to any other form to connect a monitor. An adaptor is to adapt signals in I/O channels to connect all the external devices in a subsystem. It includes a set of I/O channels, it can be only one channel in certain application, typically, it will include a video channel and an input channel for connecting a mouse; these external devices can be used by the virtual machine independent of the applications running on the master system to enable parallel processing without any I/O conflicts. The first video output channel is using LVDS signals and the first input channel is connecting the external device through USB interface. The virtual machine running in the master system can communicate with the subsystem through a control channel of the adaptor. The subsystem has an ID and the device driver will be installed when the master system detect the ID of the subsystem through the control channel of the adaptor.

Please continue to refer to FIG. 1B. In one embodiment, a power supply 133 is connected to the power management system of master system 100; the power supply 133 can be used to support all the devices in the subsystem as well. A control device 134 is connected to the internal bus or I/O channels of master system, the driver for control device 134 will be loaded when the control device 134 is connected to the master system through the connector 120. The control device 134 can collect all the information of the devices in the subsystem and store them in a storage device such as a flash memory; alternatively, if all the devices in the subsystem are fixed without any changes, then all the information of the devices in the subsystem can be fixed in the very beginning and stored into a memory such as a flash device for the master system to read; and the master system can control the sequence of loading each device driver for each devices of the subsystem 130 so that the master system can load the driver one by one to improve reliability and efficiency of loading device drivers when the subsystem is connected to the master system 100. In summary, before the VM can use the subsystem, the device driver will be loaded for connecting each external device through the adaptor, turn on the VM, and then dispatch the device driver to VM. Alternatively, the device driver can be loaded and dispatched to VM before turning on the VM. In addition, after the VM is running, a new device can be added into the subsystem and the device driver of the new device can be dynamically loaded by sending a command from the master system to VM to load a specified driver for VM itself. The command can be sent from the master system to the VM through many ways such as through network, com ports, or any available internal bridges.

The master system, such as a mobile phone or a notebook, has an operating system and its own input devices and output devices, such as a mouse and a monitor for running applications. In order to allow the master system to detect and identify the subsystem, there are many different ways to achieve that, for example, there is a dedicated pin, which can be called ID pin in the connector, which will be pulled Low when the subsystem is plugged, otherwise, the ID pin will be pulled High all the time through the master system. Once the ID pin is detected Low, the master system can turn on the second video channel for running the VM.

The master system normally run its application on a main display and a main keypad or keyboard, however, if we want to run parallel applications using virtual machine (VM), it is more convenient to use a separate monitor and a keyboard or a mouse for running the virtual machine independently without using the main display or the main touchpad or keyboard to enable truly parallel processing. The adaptor is a connector to group a set of I/O channels to connect a subsystem which can include monitor, mouse or a keyboard for running the virtual machine. We can also implement a security mechanism for check the authorization of a user before connecting the subsystem to the master system to run the virtual machine as well. The security mechanism can be installed in the control device, for example, the control device will handshake with the master system to ensure a security key is correct for getting the authorization to access the devices of subsystem.

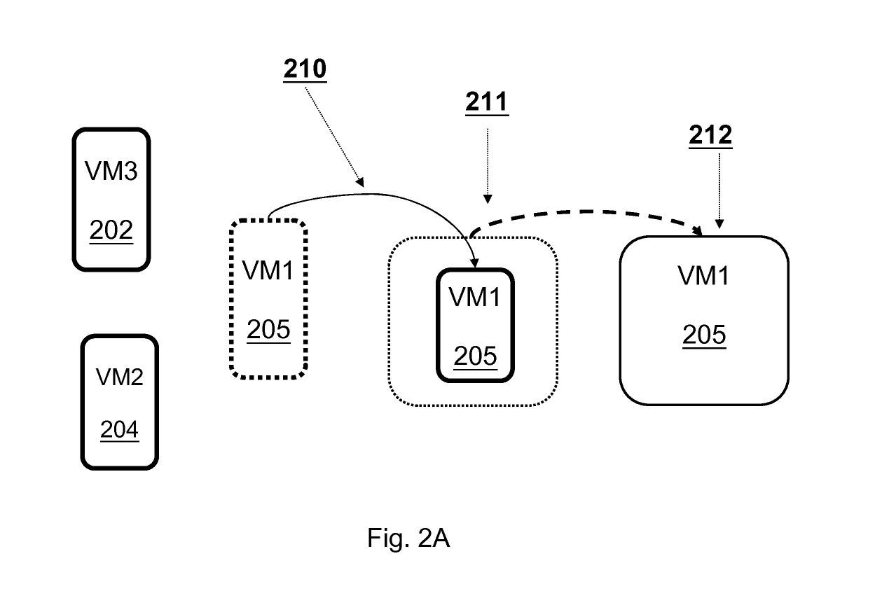

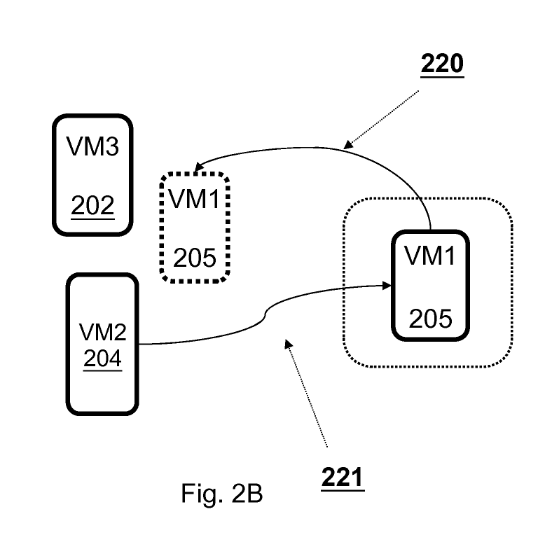

When the master system has loaded all the device of the subsystem or the subsystem is detected, it will update the status on a GUI (graphic user interface) and prompt users to run a VM or select a VM to run. As shown in FIG. 2A, there is a window for a user to select a particular VM by moving the token of a VM into the window. For example, the VM1 205, VM2 204 and VM3 202 are available for running as a virtual machine on the master system. The virtual machines VM1 205 can be activated dragging it into the window with dotted lines 211 to indicate it is starting the VM loading process, and then the dotted lines will be turned into solid lines 212 when the VM is ready.

As shown in FIG. 2B, VM1 205 can be removed from the VM window and VM2 204 can be moved into the VM window to replace the VM1 205.

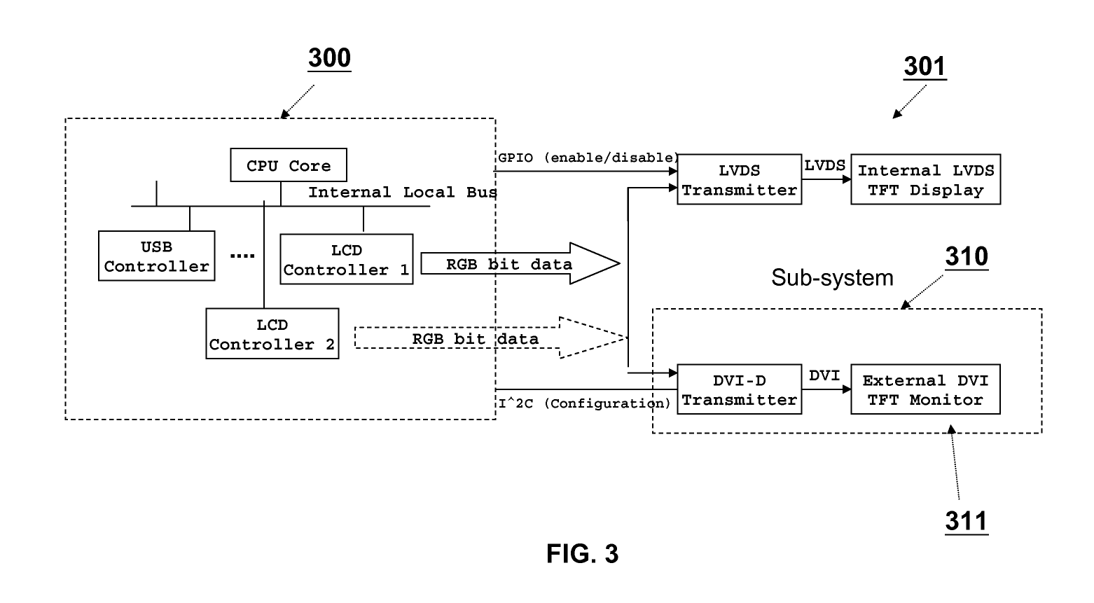

As shown in FIG. 3, master system 300 can provide multiple LCD controllers or graphic chip to deliver two video channels with different power requirements and resolutions. The graphic chip provides the first video output channel and the second video output channel. The master uses the first video output channel to connect to the Internal LVDS TFT Display 301 for running its own applications for the master system. The subsystem uses the second video output channel to connect to an External DVITFT Monitor 311 for running applications on VM. The first video output channel and the second video output channel can be swapped by an external button for flexibility. Furthermore, the first video output channel can be cut off on the master system when the second video output channel is running for the VM.

Powering up the virtualization system can be done in many different ways.

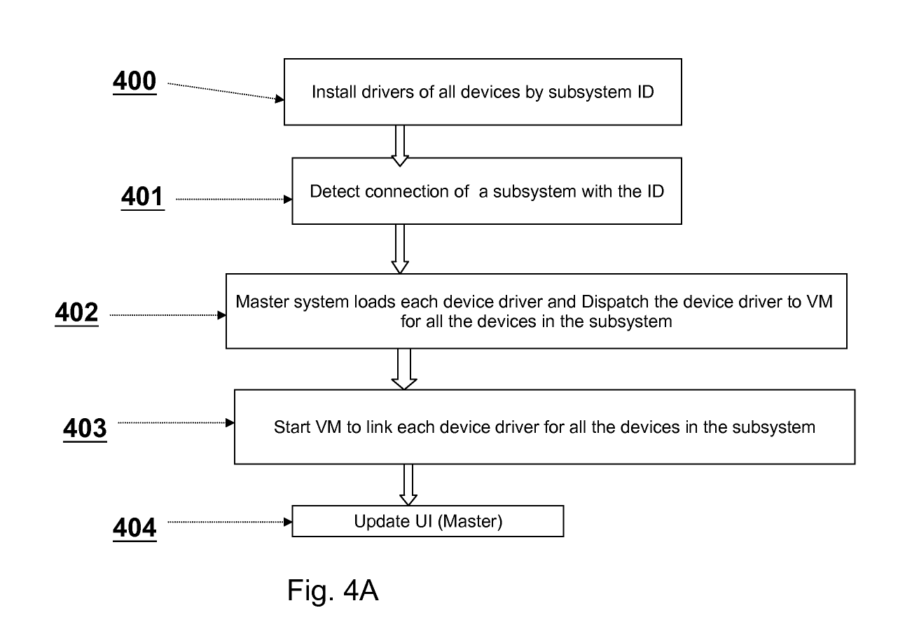

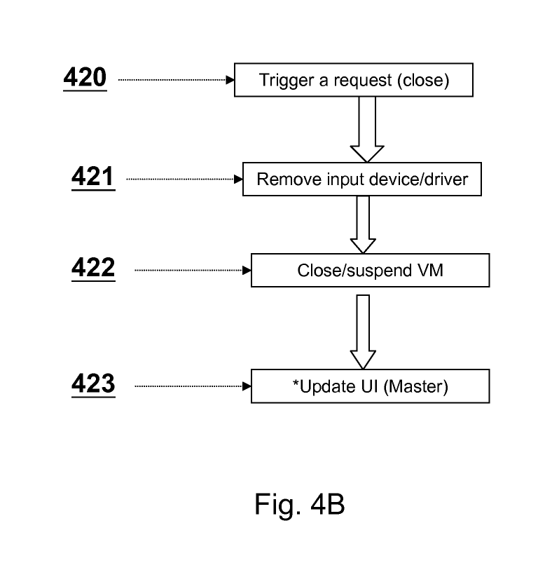

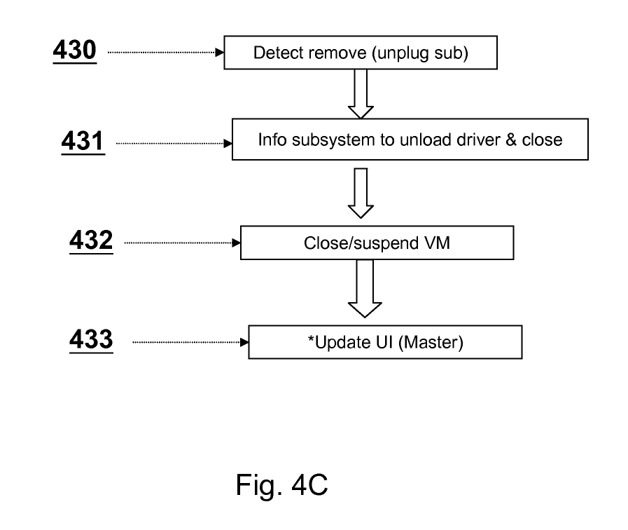

FIG. 4A shows a flow chart to start up a sub-system. In one embodiment as shown in FIG. 4A, the driver is set up by the master for a subsystem with an ID 400 first, then a subsystem with the ID is detected 401, which will trigger the master system to load the device drivers for the subsystem according to the ID of the subsystem and dispatch the device drivers to the VM 402. Then, the VM is started and all the device drivers for the subsystem are linked to the VM 403 for running applications. Optionally, the UI (user interface) can be updated 404 to indicate that the VM is ready for running applications.

Please note that the order of the step in FIG. 4A is not fixed as long as all the requirement for running the VM is met, for example, the VM can be started after the subsystem is detected or after the device drivers are loaded.

FIGS. 4B and 4C shows different ways to terminate or suspend the sub-system. The VM can be closed by removing or de-installing the device driver from the master system by a request or by detecting the connections between the master system and the subsystem automatically. Please refer to FIG. 4B. A request 420 is trigged first, and then all the device drivers will be removed or de-installed 421. Then the VM is closed or suspended 422, and the GUI is updated 423. Please refer to FIG. 4C. The subsystem is removed first 430, and then the master will be awared to de-install all the drivers 431 of the subsystem. Then the VM is closed or suspended 422, and the GUI is updated 423.

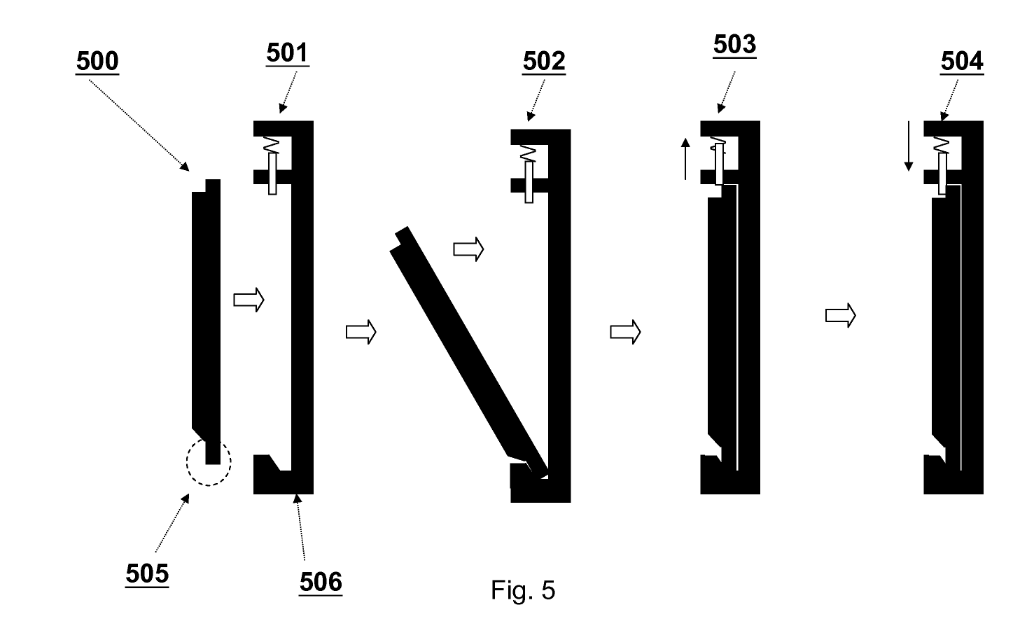

FIG. 5 shows a subsystem 501 has a mechanical base to sit the master system 500 which can be a mobile phone with a connector 505 which includes pins of a set of I/O channels for connecting with a subsystem 501, and the base of the subsystem 501 has a corresponding connector 506 to connect the connector 505. For example, the mobile phone can be place into the base so as to connect to the subsystem as illustrated in steps 502, 503 and 504. Please note that the base can have a big surface to dissipate the heat generated by the master system such as a mobile phone.

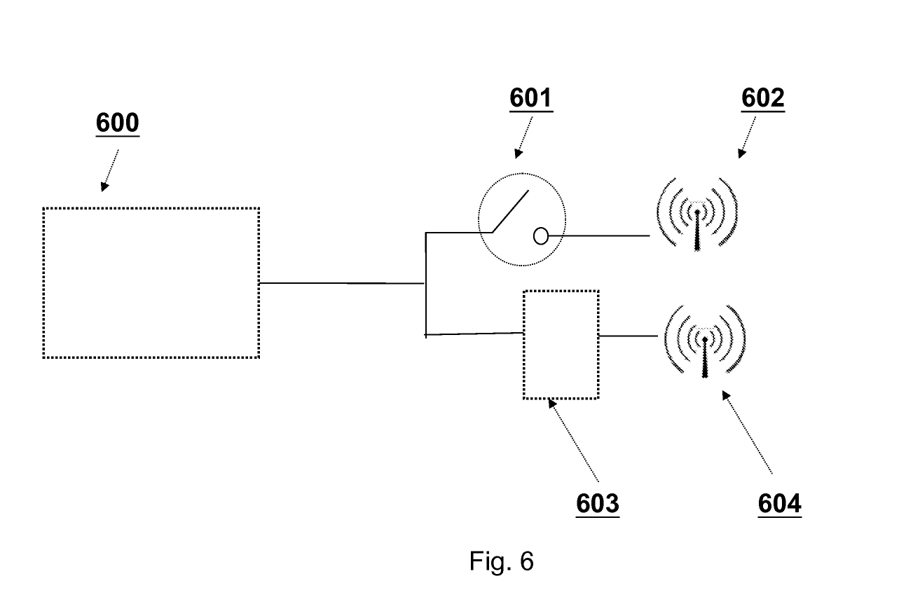

FIG. 6 shows a subsystem has an adaptor 603 which has an external wireless antenna 604 to replace an internal antenna 602 through a relay 601. The internal antenna can be switched to the external antenna for connecting with a wires device 600. For example, the relay which can be switched off when the adaptor is plugged-in so that the external antenna will be used for running the applications on the virtual machine and/or the master system to improve the quality or speed. The external antenna can replace the internal antenna in many ways, not limited to the relay; another way to do it is by using mechanical design to achieve that.

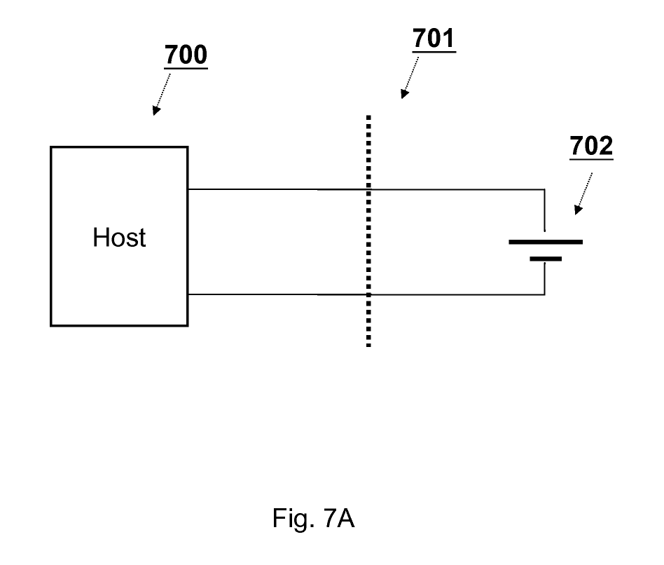

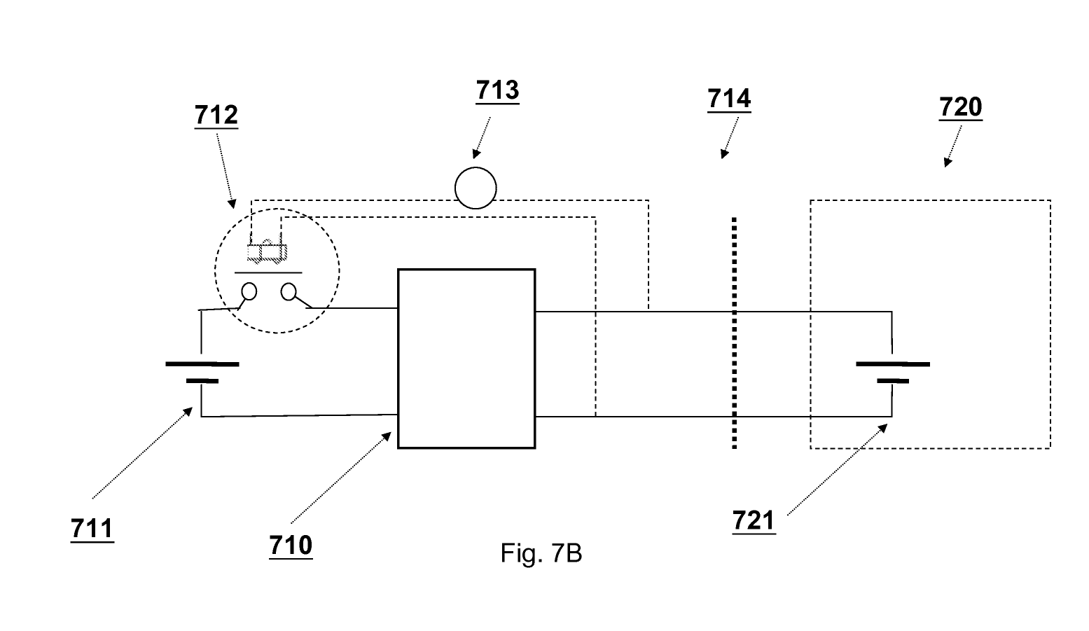

FIGS. 7A and 7B show different ways to connect an external power supply to the external adaptor. FIG. 7A shows an adaptor 701 connecting with an external power supply 702 which be used for powering the adaptor. FIG. 7B shows that a subsystem 720 has an adaptor 714 and an external power supply 720 which can replace the original power supply 711 of the master system 710 through a relay 712 with a delay 713 to ensure power is not interrupted during power supply swapping. The external power supply can replace the original power supply in many ways, not limited to the relay; another way to do it is by using mechanical design to achieve that.

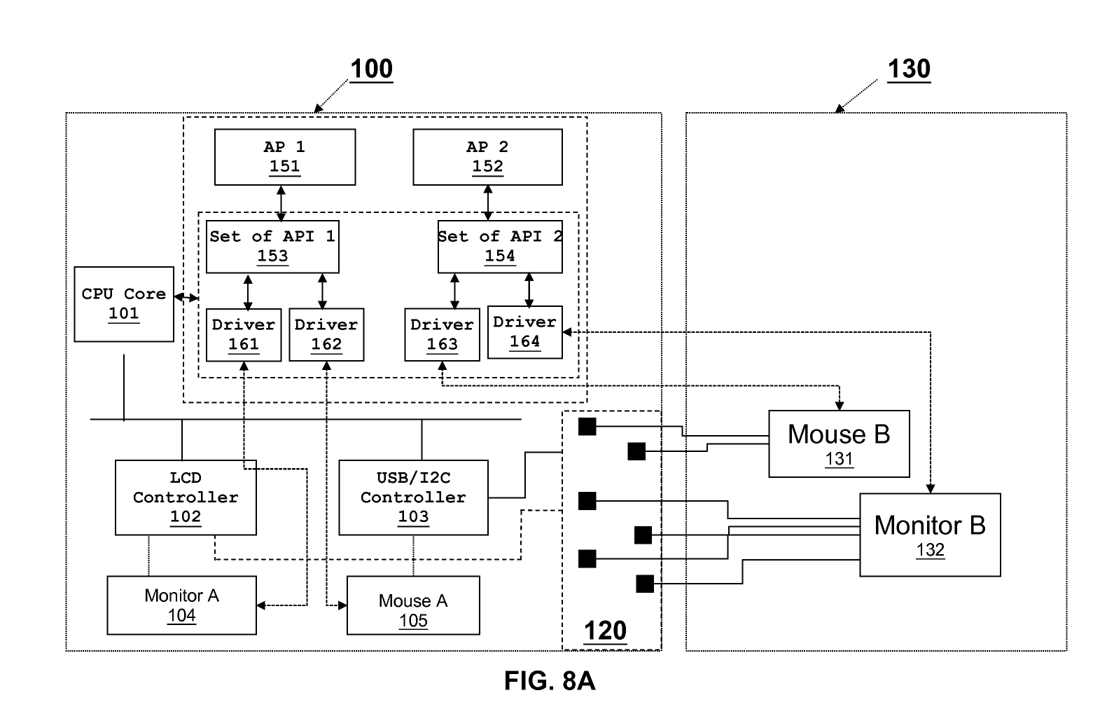

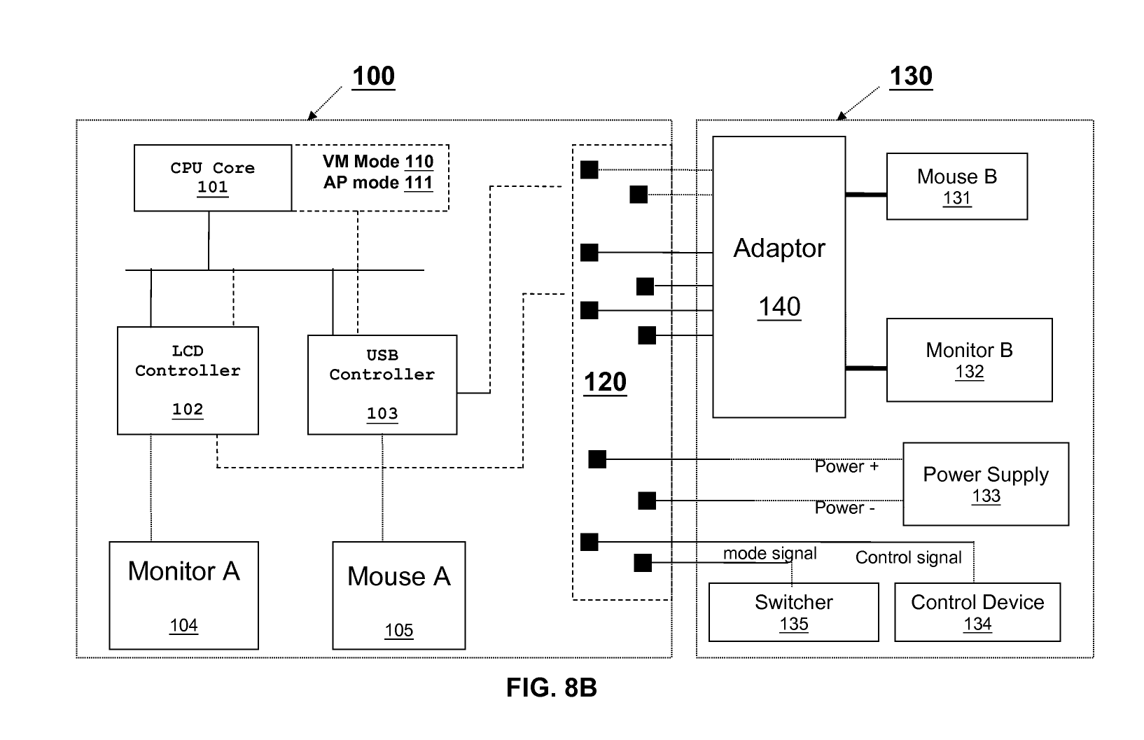

FIG. 8A shows a schematic diagram in accordance with another embodiment. There is one application AP1 151 running in the master system 100 using a monitor 104 and a mouse 105; and another application AP2 152 running on an external monitor 132, which means the application AP2 152 has its own display or monitor 132 independent of the display or monitor 104 used by the application AP1 151 in the master system 100. The AP2 151 can access the monitor 104 and the mouse 105 through one set of Application Programming Interface API_{—}1 153 which links to a monitor driver 161 and a mouse driver 162 and to access the mouse the monitor 104 and the mouse 105. The AP2 152 can access the subsystem through another set of Application Programming Interface API_{—}2 154 which links to a mouse driver 163 and a monitor driver 164 to access the mouse 131 and the monitor 132.

The master system 100 is connected to an external subsystem 130 which includes some I/O devices, such as a mouse 131, a keyboard, a monitor 132, a touch-panel, audio speaker, etc., which provides a great deal of flexibility and adaptability to any environment, such as connecting the subsystem into a desktop, a notebook, a mobile phone or any computing devices capable of running an application. By doing this way, the I/O devices used by the applications running on the master system 100 can be independent of the I/O devices used by the application AP2 152; and the I/O devices in the subsystem can be added and configured through loading a device driver corresponding to the subsystem 130 after the master system 100 is power-up and running.

Please continue to refer to FIG. 8A. In one embodiment, the master system 100 has a connector 120 for connecting with the subsystem 130. The mouse 131 is connected to the internal bus or I/O channels of master system, the driver for the mouse 131 will be loaded when the mouse 131 is connected to the master system through the connector 120. Likewise, the monitor 132 is connected to the internal bus or I/O channels of master system, the driver for the monitor 132 will be loaded when the monitor 132 is connected to the master system through the connector 120.

Please note that the master system can connect to the subsystem in passing-through mode, that is, the devices of the subsystem can be connected to the master system directly without using the connector 120. For example, a mouse of the subsystem can be connected to the master system through an existing USB port of the master system and a monitor of the subsystem can be connected to the master system through an existing HDMI port of the master system; and the subsystem can be detected by the master system through detecting the ID of the mouse or the monitor in the subsystem.

In addition, an I/O channel of the master system can be connected to an external port through the subsystem, for example, an I/O channel of the master system can be connected to a network through the subsystem, wherein the subsystem will connect the I/O channel to the network through a network port in the subsystem. Alternatively, a new device can be attached to a port of the subsystem and the new device can be assigned to the subsystem once the ID of the device is known and the loading process for the new device is done. Another example is that the subsystem will pass an I/O channel from the master system to another port in the subsystem, for example, the subsystem will receive videos on an I/O channel from the master system and transmit the video to another video port in the subsystem.

In another embodiment, as shown in FIG. 8B, an adaptor 140 which connects to a set of I/O channels of master system and can be used to convert signals form the I/O channels into suitable signals for connecting with all the devices in the subsystem 130 to improve flexibility. Adaptor comprise several kinds of interface, for example, one I/O channel has a number of pin for connecting to an input device, such as a mouse; another I/O channel has a number of pins for connecting to a display, such as a monitor; yet another I/O channel has a number of pins for connecting to an audio speaker; Please note that each I/O channel may have any number of pins assigned in the adaptor, it. The I/O channel can be connected to a device directly or indirectly through some conversions, for example, the video signals can be in VGA form or LVDS form, and they can be converted to any other form to connect a monitor. An adaptor is to adapt signals in I/O channels to connect all the external devices in a subsystem. It includes a set of I/O channels, it can be only one channel in certain application, typically, it will include a video channel and an input channel for connecting a mouse; these external devices can be used by the application independent of the applications running on the master system to enable parallel processing without any I/O conflicts. The first video output channel is using LVDS signals and the first input channel is using USB signals in the connecting bus for connecting the external device. The application running in the master system can communicate with the subsystem through a control channel of the adaptor. The subsystem has an ID and the device driver will be installed when the master system detect the ID of the subsystem through the control channel of the adaptor.

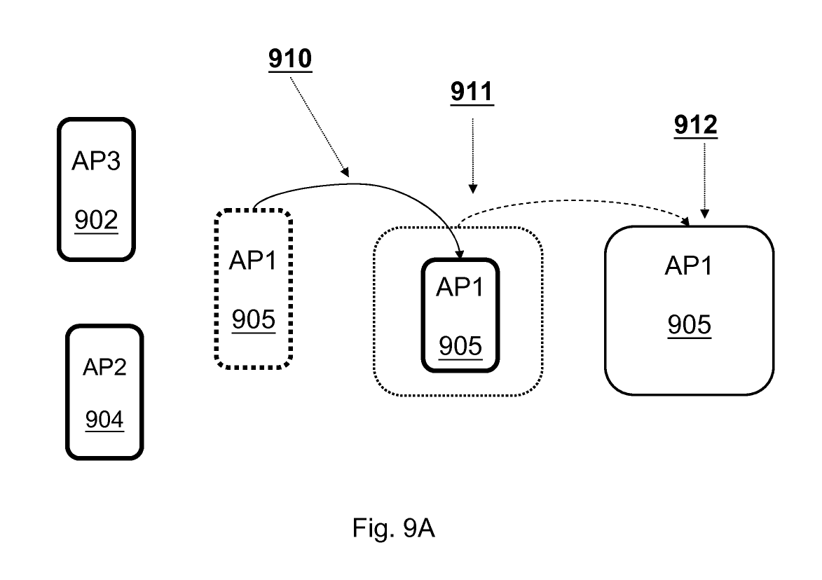

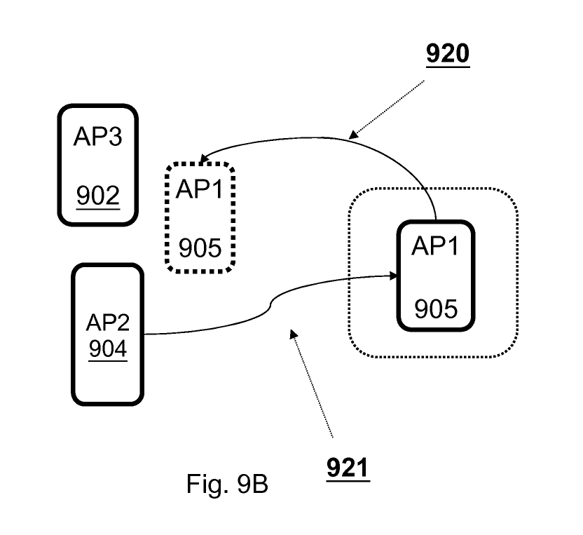

Please continue to refer to FIG. 8B. We have described an application can run on a subsystem either directly or through a virtual machine. As shown in FIG. 8B, there are two modes for running applications on the subsystem, one is VM mode 110 and the other is AP mode 111. Three is a switcher 135 in the subsystem, which can be used to select either the VM mode 110 or the AP mode 111. There are many other mechanisms can do the selection between the VM mode or AP mode, for example, through a first window for selecting the VM mode or a second window to select the AP mode as shown in FIG. 2A and FIG. 9A.

When the master system has loaded all the device of the subsystem or the subsystem is detected, it will update the status on a GUI (graphic user interface) and prompt users to run an application or select an application to run. As shown in FIG. 9A, there is a window for a user to select a particular application by moving the token of a application into the window. For example, the AP1 905, AP2 904 and AP3 902 are available for running as an application on the master system. The applications AP1 205 can be selected to run on the subsystem by dragging it into the window with dotted lines 911 to indicate it is starting the selecting process, and then the dotted lines will be turned into solid lines 912 when the AP1 205 is ready to run on the subsystem.

As shown in FIG. 9B, AP1 205 can be removed from the window and AP2 204 can be moved into the window to replace the AP 205 so that the AP 205 will run on the subsystem instead.

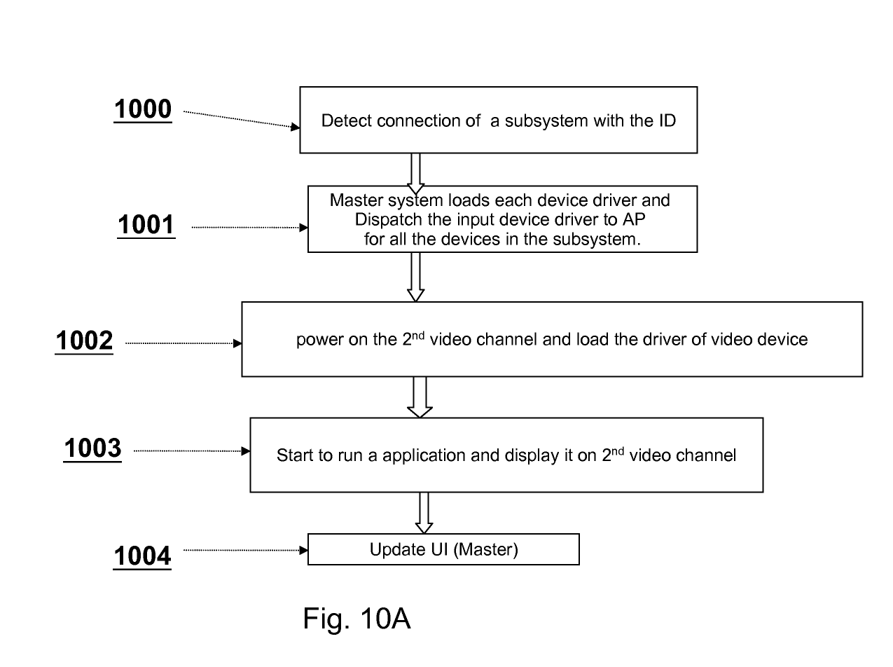

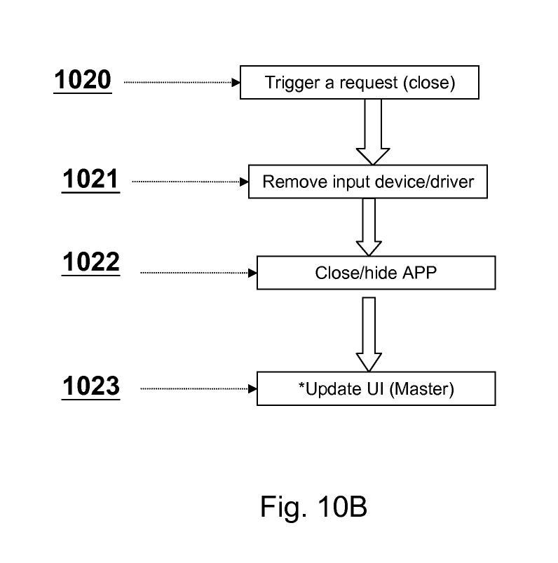

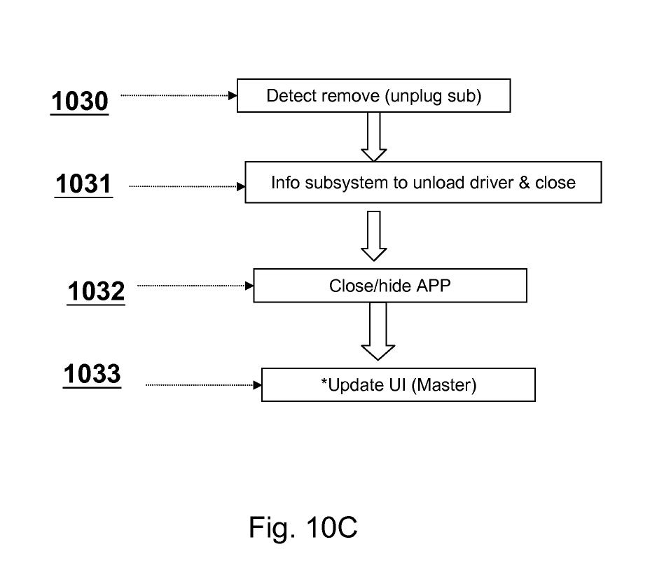

FIG. 10A shows a flow chart to start a application to run on a sub-system. In one embodiment as shown in FIG. 4A, the driver is set up by the master for a subsystem with an ID 1000 first, then a subsystem with the ID is detected 1001, which will trigger the master system to load the device drivers for the subsystem according to the ID of the subsystem and dispatch the device drivers to an AP (application) 1002. Then, the AP is started and all the device drivers for the subsystem are linked to the AP 1003 for running the AP on the subsystem. Optionally, the UI (user interface) can be updated 1004 to indicate that the AP is ready for running.

Please note that the order of the step in FIG. 10A is not fixed as long as all the requirement for running the AP is met, for example, the AP can be started after the subsystem is detected or after the device drivers are loaded.

FIGS. 10B and 10C shows different ways to terminate or suspend the sub-system. The AP can be closed by removing or de-installing the device driver from the master system by a request or by detecting the connections between the master system and the subsystem automatically. Please refer to FIG. 10B. A request 1020 is trigged first, and then all the device drivers will be removed or de-installed in step 1021. Then the AP is closed or suspended in step 1022, and the GUI is updated in step 1023. Please refer to FIG. 10C. The subsystem is removed first in step 1030, and then the subsystem will be informed to de-install all the drivers in step 1031. Then the AP is closed or suspended in step 1022, and the GUI is updated in step 1023.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A parallel system, comprising:
a master system comprising a first set of I/O channels, capable of running a first application; and
a subsystem, electrically connecting to the first set of I/O channels of the master system, having a corresponding device diver of the master system, wherein the device diver is linked to the first application to enable the first application to use the subsystem through the first set of I/O channels and the device driver independent of the master system.

2. The parallel system according to claim 1, wherein the master system comprises a first monitor to run a second application and the first set of I/O channels of master system comprises a first video output channel to connect with a second monitor in the subsystem to run the first application, wherein the first application uses the second monitor through a first application program interface (API) and the second application uses the first monitor through a second application program interface (API).

3. The parallel system according to claim 1, wherein the first set of I/O channels of master system comprises a first video output channel to connect with a first monitor and a first input channel to connect with a mouse in the subsystem.

4. The parallel system according to claim 1, wherein the master system further comprises a second set of I/O channels for running a second application on the master system, wherein the second set of I/O channels comprises a second video output channel to connect with a second monitor and a second input channel to connect with a second mouse in the subsystem.

5. The parallel system according to claim 1, wherein the first set of I/O channels of master system comprises a first control channel to allow the first application to communicate with the subsystem.

6. The parallel system according to claim 1, wherein the subsystem has an ID and the device driver will be installed when the master system detects the ID of the subsystem.

7. The parallel system according to claim 5, wherein the subsystem has an ID and the device driver will be installed when the master system detect the ID of the subsystem through a first control channel connecting with the master system and the subsystem.

8. The parallel system according to claim 5, wherein the subsystem has an ID and the device driver will be installed when the master system detect the ID of the subsystem through detecting an ID of a device in the subsystem.

9. The parallel system according to claim 3, wherein the first video output channel connects to the monitor using a HDMI port of the master system and the first input channel connects to the mouse of the subsystem using a USB port of the master system.

10. The parallel system according to claim 1, wherein the first set of the I/O channels are connected to a first connector of the master system and the subsystem further comprises a second connector to connect to the first connector.

11. The parallel system according to claim 1, wherein the first set of the I/O channels are connected to a first connector of the master system and the subsystem further comprises an adaptor having a second connector to connect to the first connector.

12. The parallel system according to claim 8, wherein the subsystem further comprises a base adapted to connect to the second connector, wherein the first connector is connected to the second connector when the master system sits in the base.

13. The parallel system according to claim 8, wherein the adaptor has a first power supply and the master system has a second power supply, wherein the second power supply is cut off after the first power supply is connected to the master system through the connector of the adaptor.

14. The parallel system according to claim 1, wherein the master system is a mobile phone, a notebook or a portable electronic device.

15. The parallel system according to claim 4, wherein the master system comprises a graphic chip to provide the first video output channel and the second video output channel, wherein the first video output channel and the second video output channel can be swapped by using a button.

16. The parallel system according to claim 1, wherein the master system displays a window to select the first application by moving a token of the first application into the window.

17. A method to run a parallel system, comprising the steps of:
a. detecting connection of a subsystem with the ID;
b. identifying each device driver and dispatch the device driver to a first application for each device in the subsystem;
c. starting the first application to link each device driver for each device in the subsystem.

18. The method to run a parallel system according to claim 17, wherein said each device driver of the subsystem is preload into the master system.

19. The method to run a parallel system according to claim 18, further comprising the steps of:
d. removing the device driver from the master system; and
e. closing the first application.
